(19) United States
(12) Patent Application Publication
(10) Pub. No.: US 2016/0306205 A1
(43) Pub. Date: Oct. 20, 2016

(54) LIQUID CRYSTAL DISPLAY PANEL AND SEALANT APPLICATOR

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Yuansheng ZANG, Beijing (CN); Chun WANG, Beijing (CN); Yuanhui GUO, Beijing (CN); Ronghua JIN, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/096,940

(22) Filed: Apr. 12, 2016

(30) Foreign Application Priority Data
Apr. 17, 2015 (CN) 201510185780.6

(51) Int. Cl. G02F 1/1339; G02F 1/13

(52) U.S. Cl. CPC G02F 1/1339; G02F 1/1303

(57) ABSTRACT

A liquid crystal display panel and a sealant applicator are disclosed. The liquid crystal display panel includes a first substrate and a second substrate arranged opposite to each other to form a cell, a liquid crystal layer between the first substrate and the second substrate, and a sealant configured to adhere the first substrate to the second substrate. The liquid crystal display panel further includes a barrier layer configured to separate the sealant from liquid crystals. The sealant applicator includes a first nozzle configured to apply a sealant onto the first substrate, so as to enable the first substrate to be adhered to the second substrate; and a second nozzle configured to apply a material for forming a barrier layer to a periphery of the sealant applied by the first nozzle, so as to enable the barrier layer to separate the sealant from liquid crystals in the liquid crystal layer.

### CROSS-REFERENCE TO RELATED APPLICATION

The present application claims a priority of the Chinese patent application No. 201510185780.6 filed on Apr. 17, 2015, which is incorporated herein by reference in its entirety.

### TECHNICAL FIELD

The present disclosure relates to the field of display technology, in particular to a liquid crystal display panel and a sealant applicator.

### BACKGROUND

Recently, a thin film transistor liquid crystal display (TFT-LCD) has been developed rapidly and become a mainstream in the market due to its advantages such as small volume, low power consumption and being free of radiation.

As one of the critical materials for the cell-formation process of the TFT-LCD, a sealant mainly includes matrix resin, a curing agent, a filler and a coupling agent. The matrix resin may be cured thermally or by ultraviolet (UV) light. When the UV-curing process is adopted, the matrix resin may be cured rapidly, and when the thermocuring process is adopted, it may take much time for curing the matrix resin at a high temperature. Currently, the sealant is usually pre-cured by the UV light, and then thermally cured, so as to be completely cured. For a small-size display panel, after a color filter substrate and an array substrate are arranged opposite to each other to form a cell, liquid crystals may be dispersed to the entire display region and in contact with the uncured sealant. Although the sealant may be pre-cured by the UV light immediately after the cell is formed, the pre-cured sealant may include a large umber of small-molecule substances, e.g., the coupling agent and the curing agent. When the sealant is subsequently thermally cured for a long period of time at a low speed, the liquid crystals may be in contact with the sealant that is not completely cured for a long period of time. At this point, the small-molecule substances may enter into a liquid crystal layer, so the liquid crystals may be polluted and the alignment of the liquid crystals may be changed. As a result, such imperfections as yellowish phenomenon, push Mura (uneven brightness for an image) and afterimage will occur, and the image quality will be adversely affected.

### SUMMARY

In view of this, the present disclosure provides a liquid crystal display panel and a sealant applicator, so as to prevent the small-molecule substances of the sealant from entering the liquid crystal layer, thereby to prevent the image quality from being adversely affected.

In one aspect, the present disclosure provides in sonic embodiments a liquid crystal display panel, including a first substrate, a second substrate, a liquid crystal layer, a sealant and a barrier layer. The first substrate and the second substrate are arranged opposite to each other to form a cell. The liquid crystal layer is between the first substrate and the second substrate. The first substrate is adhered to the second substrate through the sealant. The barrier layer separates the sealant from liquid crystals in the liquid crystal layer.

Optionally, the barrier layer is a selective permeable film capable of allowing a gas generated when the sealant is cured to pass therethrough.

Optionally, the barrier layer is viscous and encloses the sealant.

Optionally, the barrier layer covers a surface of the sealant facing the liquid crystal layer.

Optionally, the barrier layer is made of polyester.

In another aspect, the present disclosure provides in some embodiments a sealant applicator for a liquid crystal display panel. The liquid crystal display panel includes a first substrate and a second substrate arranged opposite to each other to form a cell, and a liquid crystal layer between the first substrate and the second substrate. The sealant applicator includes: a first nozzle configured to apply a sealant onto the first substrate of the liquid crystal display panel, so as to enable the first substrate to be adhered to the second substrate; and a second nozzle configured to apply a material for forming a barrier layer to a periphery of the sealant applied by the first nozzle, so as to enable the barrier layer to prevent the sealant from being in contact with liquid crystals in the liquid crystal layer.

Optionally, an outlet of the second nozzle surrounds a periphery of an outlet of the first nozzle.

Optionally, the first nozzle is of a rounded shape and the second nozzle is of a ring shape, or the first nozzle is of a polygonal shape and the second nozzle is of a polygonal ring shape.

Optionally, a difference between an inner radius of the second nozzle of the ring shape and a radius of the first nozzle of the rounded shape is less than a predetermined value.

Optionally, the inner radius of the second nozzle is equal to the radius of the first nozzle.

Optionally, the sealant applicator further includes a first cylinder configured to drive the first nozzle, and a second cylinder configured to drive the second nozzle at a predetermined pressure so as to apply the material for forming the barrier layer at the periphery of the sealant when the sealant is applied by the first nozzle.

Optionally, the first cylinder includes a piston rod and a first plate on the piston rod of the first cylinder; the first plate is slidably arranged in the first nozzle. The second cylinder includes a piston rod and a second plate on the piston rod of the second cylinder; the second plate is slidably arranged in the second nozzle.

Optionally, the first plate is of a disc shape.

Optionally, the second plate is of a ring shape and sleeved onto the first nozzle.

According to the liquid crystal display panel and the sealant applicator in the embodiments of the present disclosure, the barrier layer is arranged at the periphery of the sealant, so as to prevent the small-molecule substances of the sealant from entering into the liquid crystal layer before the sealant has been completely cured, thereby to prevent the occurrence of such imperfections as a yellowish phenomenon, push Mura and afterimages, and improve the image quality. In addition, the selective permeable film is arranged on the surface of the sealant, so as to allow gas molecules to pass therethrough. As a result, it is able to prevent a cell thickness of the liquid crystal display panel from being increased due to the barrier layer, thereby to prevent the performance of the liquid crystal display panel from being adversely affected.

### BRIEF DESCRIPTION OF THE DRAWINGS

FIG. 1 is a schematic view showing a liquid crystal display panel according to one embodiment of the present disclosure;

FIG. 2 is another schematic view showing the liquid crystal display panel according to one embodiment of the present disclosure;

FIG. 3A is a schematic view showing a first substrate, a second substrate and a barrier layer of the liquid crystal display panel according to one embodiment of the present disclosure;

FIG. 3B is a schematic view showing the liquid crystal display panel after the first substrate and the second substrate are arranged opposite to each other to form a cell according to one embodiment of the present disclosure;

FIG. 4 is a schematic view showing nozzles of a sealant applicator for the liquid crystal display panel according to one embodiment of the present disclosure.

FIG. 5 is a sectional view along a line A-A in FIG. 4; and

FIG. 6 is another schematic view showing the nozzles of the sealant applicator according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in conjunction with the drawings and embodiments.

The present disclosure provides in some embodiments a liquid crystal display panel. As shown in FIG. 1, the liquid crystal display panel includes a first substrate 101, a second substrate 102, a liquid crystal layer 103 and a sealant 104. The first substrate 101 and the second substrate 102 are arranged opposite to each other to form a cell. The liquid crystal layer 103 is arranged between the first substrate 101 and the second substrate 102. The first substrate 101 is adhered to the second substrate 102 through the sealant 104. The liquid crystal display panel further includes a barrier layer 105. The barrier layer 105 prevents the sealant 104 from being in contact with liquid crystals in the liquid crystal layer 103.

According to the liquid crystal display panel in the embodiments of the present disclosure, the barrier layer 105 is arranged between the sealant 104 and the liquid crystal layer 103, and the barrier layer 105 can block small-molecule liquid substances in the sealant 104 from entering the liquid crystal layer 103 when the sealant 104 is not completely cured, thereby preventing the liquid crystal layer 103 from being polluted by the sealant 104 and then preventing the occurrence of such imperfections as a yellowish phenomenon, push Mura and afterimages, and improve the image quality. In addition, because the small-molecule substances in the sealant cannot enter the liquid crystal layer, no pre-curing process for the sealant is needed during the manufacture of the liquid crystal display panel, so it is able to reduce the process steps.

In some embodiments of the present disclosure, the barrier layer 105 may be any layer capable of preventing the substances in the sealant from entering the liquid crystal layer and preventing the liquid crystals from entering the sealant, e.g., a polyester film. The harrier layer 105 may be applied onto a surface of the sealant 104 facing the liquid crystal layer 103, or may enclose the entire sealant 104. The sealant 104 is configured to adhere the first substrate 101 to the second substrate 102. In the embodiments of the present disclosure, the sealant 104 may be a thermos-curable sealant, or a UV-curable sealant.

Because the sealant may be cured rapidly by the UV light, alternatively, the sealant 104 is a UV-curable sealant.

In some embodiments of the present disclosure, the first substrate 101 is one of an array substrate and a color filter substrate, and the second substrate 102 is the other one of the array substrate and the color filter substrate. During the manufacture of the liquid crystal display panel, a color filter film may be formed on the first substrate 101, a TFT array may be formed on the second substrate 102, and the liquid crystals may be dripped onto the TFT array substrate. The sealant 104 enclosed with the barrier layer 105 may be applied onto the color filter substrate, the first substrate 101 and the second substrate 102 are arranged opposite to each other to form a cell in a Vacuum Alignment System (VAS), and then the sealant 104 is cured, so as to form the liquid crystal display panel.

In some embodiments of the present disclosure, the barrier layer 105 may be a selective permeable film capable of allowing a gas generated when the sealant 104 is cured to pass therethrough. The selective permeable film may be any film capable of allowing gas molecules to pass therethrough but prohibiting non-gas molecules from passing therethrough.

In most cases, a gas may be generated when the sealant is thermally cured. When the barrier layer 105 does not allow any substances to pass therethrough, the generated gas may be kept in the barrier layer 105. At this point, a gap between the first substrate 101 and the second substrate 102 may be increased, and thereby the cell thickness may be increased too. Hence, in some embodiments of the present disclosure, the selective permeably film may be selected as the barrier layer 105, so as to allow the gas molecules to pass therethrough and prohibit the non-gas molecules, e.g., solid and liquid molecules, from passing therethrough. In this way, the gas generated when the sealant 104 is cured may be discharged to the outside of the barrier layer 105, so as to prevent the cell thickness from being increased.

In some embodiments of the present disclosure, the barrier layer 105 is viscous and completely encloses the sealant 104. Through the viscous barrier layer 105, it is able to prevent the adhesion of the sealant 104 from being adversely affected even when the sealant 104 is completely enclosed by the barrier layer 105.

When the barrier layer 105 is viscous and completely encloses the sealant 104, the gas generated when the sealant is cured may, due to the presence of the liquid crystal layer 103, the first substrate 101 and the second substrate 102, be discharged from a surface of the barrier layer 105 not in contact with the first substrate 101, the second substrate and the liquid crystal layer 103.

In some embodiments of the present disclosure, the barrier layer covers a surface of the sealant 104 facing the liquid crystal layer.

When the barrier layer does not completely enclose the sealant, the gas generated when the sealant is cured may be discharged from the surface of the sealant that is not covered by the barrier layer. At this point, the barrier layer may be a film that does not allow any substances to pass therethrough. Although small-molecule substances in the sealant may flow from a periphery of the barrier layer into the liquid crystal layer, the barrier layer may still be used to prevent the liquid crystal layer from being polluted by the sealant to some extent, thereby to prevent somewhat the occurrence of such imperfections as a yellowish phenomenon, push Mura and afterimages.

The barrier layer mainly functions as to prevent the substances in the from entering the liquid crystal layer, so in some embodiments of the present disclosure, the barrier layer may be merely arranged on the surface of the sealant facing the liquid crystal layer.

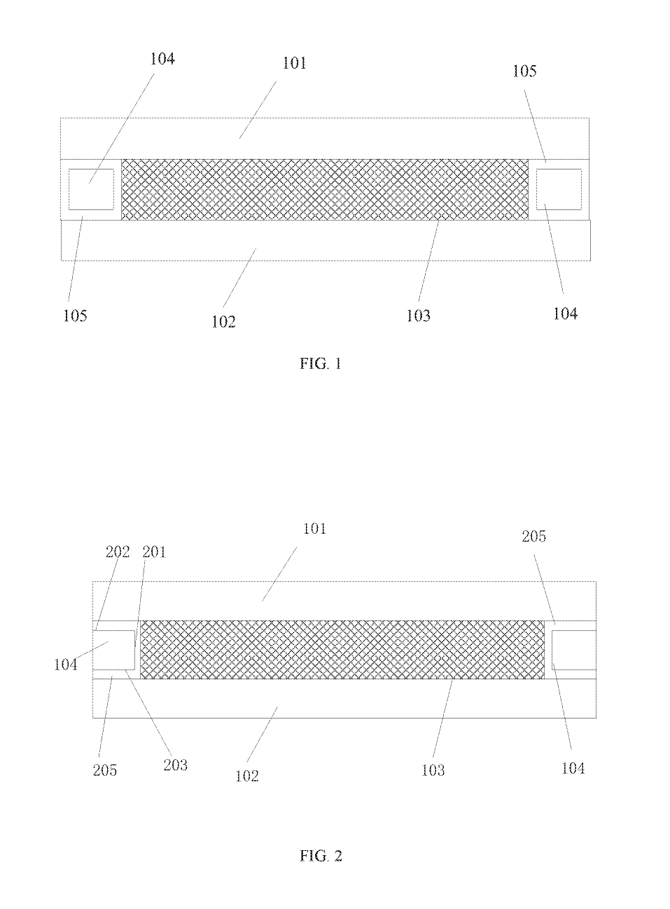

In one embodiment, as shown in FIG. 2, a barrier layer 205 may cover a first surface 201 of the sealant 104 facing the liquid crystal layer 103, a second surface 202 of the sealant 104 facing the first substrate 101 and a third surface 203 of the sealant 104 facing the second substrate 102. As compared with the situation where the barrier layer merely covers the surface of the sealant facing the crystal layer 103, this embodiment may improve the barrier effect. As compared with the situation where the barrier layer completely encloses the sealant, this embodiment may reduce the amount of the material for forming the barrier layer. In addition, the barrier layer 205 in FIG. 2 may be a film that does not allow any substances to pass therethrough and as compared with the selective permeable film, it is able to reduce the production cost.

In some other embodiments of the present disclosure, in order to discharge the gas generated when the sealant is cured in a better manner, the barrier layer may completely cover the sealant, the portions of the barrier layer on the first surface of the sealant 104 facing the liquid crystal layer, on the second surface of the sealant facing the first substrate and on the third surface of the sealant facing the second substrate may be made of a material that does not allow any substances to pass therethrough, and the portion of the barrier layer on a fourth surface of the sealant facing the outside may be the selective permeable film so as to discharge the gas to the outside.

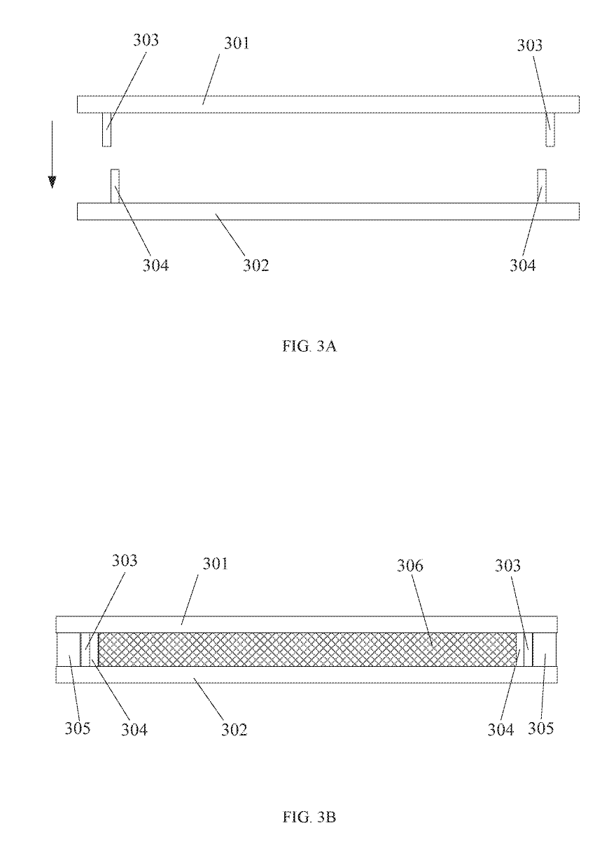

In some embodiments of the present disclosure, before the first substrate and the second substrate are arranged opposite to each other to form a cell. the barrier layer may be separated from the first substrate and the second substrate, or secured onto the first or second substrate. As shown in FIG. 3A, a first barrier layer 303 and a second barrier layer 304 are arranged at peripheries of a first substrate 301 and a second substrate 302 respectively. After the first substrate 301 and the second substrate 302 are arranged opposite to each other to form a cell, the first barrier layer 303 and the second barrier layer 304 are arranged between a sealant 305 and a liquid. crystal layer 306. As shown in FIG. 3B, the first barrier layer 303 is arranged at a position of the first substrate 301 slightly shifted from the second barrier 304, so that the first barrier layer 303 and the second barrier layer 304 are arranged immediately adjacent to each other after the first substrate 301 and the second substrate 302 are arranged opposite to each other to form a cell.

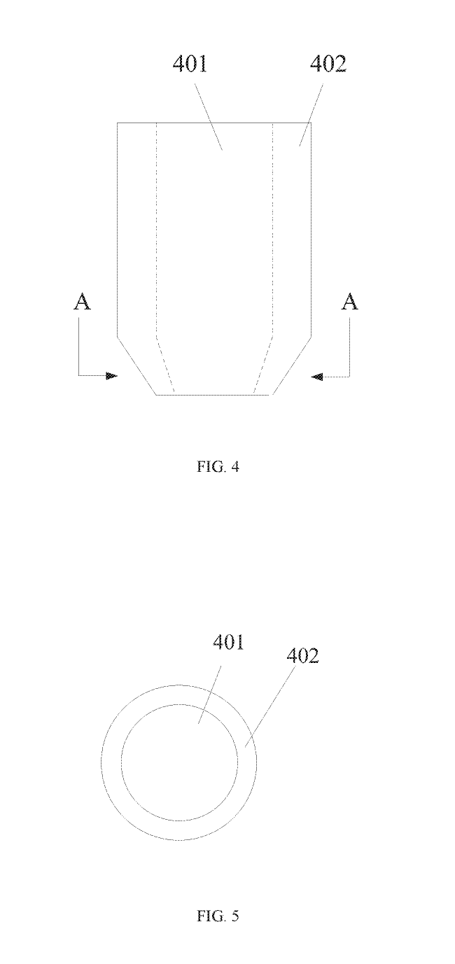

As shown in FIG. 4, the present disclosure further provides in some embodiments a sealant applicator for a liquid crystal display panel. The liquid crystal display panel includes a first substrate and a second substrate arranged opposite to each other to form a cell, and a liquid crystal layer arranged between the first substrate and the second substrate. The sealant applicator includes: a first nozzle 401 configured to spray a sealant onto the first substrate of the liquid crystal display panel, so as to enable the first substrate to be adhered to the second substrate; and a second nozzle 402 configured to spray a material for forming a barrier layer to a periphery of the sealant sprayed by the first nozzle, so as to enable the barrier layer to prevent the sealant from being in contact with liquid crystals in the liquid crystal layer.

According to the sealant applicator in the embodiments of the present disclosure, it is able to apply the sealant for the above-mentioned liquid crystal display panel. In addition, through the second nozzle 402, it is able to spray the material for forming the barrier layer at the periphery of the sealant, so as to enclose the sealant by the barrier layer and prevent the small-molecule substances in the sealant from entering the liquid crystal layer, thereby to prevent the occurrence of such imperfections as a yellowish phenomenon, push Mura and afterimages, and improve the image quality.

It should be appreciated that, the sealant applicator may include a driving mechanism, a material delivery mechanism and a material storage mechanism. The driving mechanism is configured to move the materials for forming the sealant and the barrier layer. The material delivery mechanism is configured to deliver the materials for forming the sealant and the barrier layer. The material storage mechanism is configured to store the materials for forming the sealant and the barrier layer.

In sonic embodiments of the present disclosure, an outlet of the second nozzle 402 surrounds a periphery of an outlet of the first nozzle 401. The first nozzle 401 may be a known nozzle for applying the sealant in the related art. To be specific, the second nozzle 402 for spraying the material for forming the barrier layer may be arranged at the periphery of the known nozzle for applying the sealant, and then the mechanisms for storing and delivering the materials for forming the barrier layer may be added, so as to acquire the sealant applicator in FIG. 4, thereby to apply e sealant and apply the barrier layer at the periphery of the sealant simultaneously.

In some embodiments of the present disclosure, as shown in FIG. 5, which is a sectional view showing the outlets of the first nozzle 401 and the second nozzle 402 along line A-A in FIG. 4, the outlet of the first nozzle 401 is of a rounded shape, and the second nozzle 402 is of a ring shape enclosing the first nozzle 401. An inner wall of the second nozzle 402 is just an outer wall of the first nozzle 401, and the first nozzle 401 is separated from the second nozzle 402, so as to prevent the material for forming the sealant and the material for forming the barrier layer from being mixed with each other. The barrier layer is thin, and after the material for forming the barrier layer is applied by the second nozzle 402, it may be cured rapidly. Hence, the material for forming the barrier layer may not enter the liquid crystal layer, and meanwhile the barrier layer may be used to prevent the small-molecule substances in the sealant from entering the liquid crystal.

In some embodiments of the present disclosure, the first nozzle 401 is of a rounded shape and the second nozzle 402 is of a ring shape, or the first nozzle 401 is of a polygonal shape and the second nozzle 402 is of a polygonal ring shape.

in the above embodiments, the second nozzle 402 is arranged immediately adjacent to a side surface of the first nozzle 401, and the material for forming the barrier layer from the second nozzle 402 may completely enclose the sealant sprayed from the first nozzle 401. Through the cooperation of the second nozzle 402 with the first nozzle 401, it is able to acquire the sealant with the barrier layer as shown in FIG. 1.

In some embodiments of the present disclosure, a difference between an inner radius of the ring-shaped second nozzle 402 and a radius of the rounded first nozzle 401 is less than a predetermined value.

In some embodiments of the present disclosure, when the barrier layer merely covers a surface of the sealant facing the liquid crystal layer, the outlet of the first nozzle 401 is of a rounded shape, and the outlet of the second nozzle 402 is of an arc shape, i.e., the second nozzle 402 does not completely enclose the first nozzle 401, so that the barrier layer formed by the material from the second nozzle 402 merely covers a portion of the sealant. When the second nozzle 402 is about three quarters of a ring, the barrier layer formed by the material from the second nozzle 402 may cover about three quarters of the surface of the sealant formed by the material from the first nozzle 401. At this point, three side surfaces of the sealant, which has two end surfaces and four side surfaces, may be covered by the barrier layer formed by the material from the second nozzle 402. Relative positions of the second nozzle 402 to the substrates may be adjusted, an as to enable the barrier layer to cover the surfaces of the sealant facing the first substrate, the second substrate and the liquid crystal layer, thereby to acquire the sealant with the barrier layer as shown in FIG. 2.

In some embodiments of the present disclosure, when the barrier layer on the surface of the sealant facing the liquid crystal layer is a selective permeable film and the barrier layer on the other surfaces of the sealant is made of a conventional barrier material, the second nozzle may be provided with corresponding channels so as to apply different materials.

In some embodiments of the present disclosure, the inner radius of the ring-shaped second nozzle is equal to the radius of the rounded first nozzle.

Optionally, the first nozzle may be separated from the second nozzle at an appropriate interval, so as to apply the material for forming the barrier layer onto the sealant evenly.

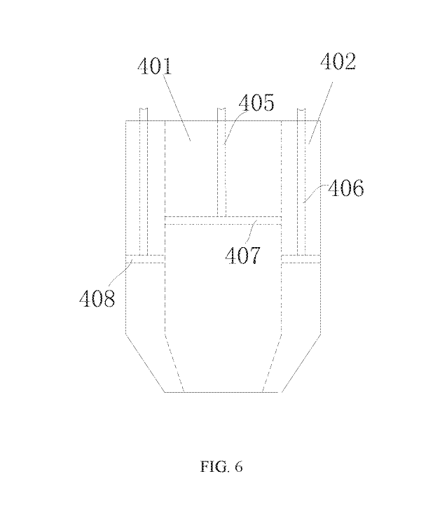

In some embodiments, as shown in FIG. 6, the sealant applicator further includes a first cylinder 405 configured to drive the first nozzle, and a second cylinder 406 configured to drive the second nozzle at a predetermined pressure so as to apply the material for forming the barrier layer at the periphery of the sealant at the time when the sealant is applied by the first nozzle.

FIG. 6, a first plate 407 is arranged on a piston rod of the first cylinder 405, and a second plate 408 is arranged on a piston rod of the second cylinder 406. The first plate 407 is slidably arranged in the first nozzle, and is of an approximately disc shape. The second plate 408 is slidably arranged in the second nozzle, and is of an approximately ring shape and sleeved onto the first nozzle.

The material for forming the barrier layer may have density and flowability different from the material for forming the sealant. When the material for forming the barrier layer is applied by the nozzle, a thrust force desired for injecting the material is different from that desired for injecting the material for forming the sealant. Hence, in some embodiments, the two cylinders may be provided, so as to drive the first nozzle and the second nozzle respectively with different thrust forces, thereby to enable the material for forming the barrier layer to completely or partially cover the sealant when the material for forming the sealant is applied by the first nozzle. In this way, it is able to prevent the time desired for the entire application process from being prolonged due to the formation of the additional barrier layer. In addition, the sealant is covered with the barrier layer, so an original pre-curing process using the UV light in the related art may be omitted, no as to reduce the time desired for the cell formation, increase the production efficiency and reduce the power consumption.

According to the liquid crystal display panel and the sealant applicator in the embodiments of the present disclosure, the barrier layer is arranged at the periphery of the sealant, so as to prevent the small-molecule substances of the sealant from entering into the liquid crystal layer before the sealant has been completely cured, thereby to prevent the occurrence of such imperfections as a yellowish phenomenon, push Mura and afterimages, and improve the image quality. In addition, the selective permeable film is arranged on the surface of the sealant, on as to allow gas molecules to pass therethrough. As a result, it is able to prevent a cell thickness of the liquid crystal display panel from being increased due to the barrier layer, thereby to prevent the performance of the liquid crystal display panel from being adversely affected. Moreover, it is able to simply the sealant application process, reduce the power consumption and increase the production efficiency.

It should be appreciated that, the above embodiments are for illustrative purposes only, but shall not be used to limit the scope of the present disclosure. In the case of no conflict, the embodiments of the present disclosure and the features described therein may be combined.

The above are merely the preferred embodiments of the present disclosure. It should be appreciated that, a person skilled in the art may make further modifications and improvements without departing from the spirit of the present disclosure, and these modifications and improvements shall also fall within the scope of the present disclosure.

What is claimed is:

1. A liquid crystal display panel comprising a first substrate, a second substrate, a liquid crystal layer, a sealant and a barrier layer;
wherein the first substrate and the second substrate are arranged opposite to each other to form a cell; the liquid crystal layer is between the first substrate and the second substrate; the first substrate is adhered to the second substrate through the sealant; the barrier layer separates the sealant from liquid crystals in the liquid crystal layer.

2. The liquid crystal display panel according to claim 1, wherein the barrier layer is a selective permeable film capable of allowing a gas generated when the sealant is cured to pass therethrough.

3. The liquid crystal display panel according to claim 1, wherein the barrier layer is viscous and encloses the sealant.

4. The liquid crystal display panel according to claim 1, wherein the barrier layer covers a surface of the sealant facing the liquid crystal layer.

5. The liquid crystal display panel according to claim 1, wherein the barrier layer is made of polyester.

6. A sealant applicator for a liquid crystal display panel, the liquid crystal display panel comprising a first substrate and a second substrate arranged opposite to each other to form a cell, and a liquid crystal layer arranged between the first substrate and the second substrate; the sealant applicator comprising:
a first nozzle configured to apply a sealant onto the first substrate of the liquid crystal display panel, so as to enable the first substrate to be adhered to the second substrate; and
a second nozzle configured to apply a material for forming a barrier layer to a periphery of the sealant applied by the first nozzle, so as to enable the barrier layer to separate the sealant from liquid crystals in the liquid crystal layer.

7. The sealant applicator according to claim 6, wherein an outlet of the second nozzle surrounds a periphery of an outlet of the first nozzle.

8. The sealant applicator according to claim 7, wherein the first nozzle is of a rounded shape and the second nozzle is of a ring shape, or the first nozzle is of a polygonal shape and the second nozzle is of a polygonal ring shape.

9. The sealant applicator according to claim 8, wherein a difference between an inner radius of the second nozzle of the ring shape and a radius of the first nozzle of the rounded shape is less than a predetermined value.

10. The sealant applicator according to claim 9, wherein the inner radius of the second nozzle is equal to the radius of the first nozzle.

11. The sealant applicator according to claim 6, further comprising:
a first cylinder configured to drive the first nozzle; and
a second cylinder configured to drive the second nozzle at a predetermined pressure so as to apply the material for forming the barrier layer at the periphery of the sealant when the sealant is applied by the first nozzle.

12. The sealant applicator according to claim 11, wherein the first cylinder comprises a piston rod and a first plate on the piston rod of the first cylinder; the first plate is slidably arranged in the first nozzle;
wherein the second cylinder comprises a piston rod and a second plate on the piston rod of the second cylinder; the second plate is slidably arranged in the second nozzle.

13. The sealant applicator according to claim 12, wherein the first plate is of a disc shape.

14. The sealant according to claim 12, wherein the second plate is of a ring shape and sleeved onto the first nozzle.
